(19) United States
(12) Patent Application Publication
(10) Pub. No.: US 2010/0296117 A1
(43) Pub. Date: Nov. 25, 2010

(54) SCALING IMAGES USING MATCHED COMPONENTS IN A DUAL ENGINE SYSTEM

(76) Inventors: Michael T. Dobbertin, Honeoya, NY (US); Alan E. Rapkin, Pittsford, NY (US)

Correspondence Address: EASTMAN KODAK COMPANY;PATENT LEGAL STAFF, 343 STATE STREET, ROCHESTER, NY, 14650-2201, US

(21) Appl. No.: 12/468,315

(22) Filed: May 19, 2009

(51) Int. Cl. G06F 15/00

(52) U.S. Cl. 358/1.15

(57) ABSTRACT

A method for making adjustable magnified images in a plurality of physically coupled print engines by selecting matched printer components for certain critical components within the coupled print engines in order to minimize the differences in a printed image size in the physically coupled print engines.

### CROSS REFERENCE TO RELATED APPLICATIONS

This application relates to commonly assigned, copending U.S. application Ser. No. ______ (Docket No. 95545DPS), filed ______, entitled: “DUAL ENGINE SYNCHRONIZATION”, U.S. application Ser. No. ______ (Docket No. 95546DPS), filed ______, entitled: “PRINT ENGINE SPEED COMPENSATION”, and U.S. application Ser. No. ______ (Docket No. 95547DPS), filed ______, entitled: “SCALING IMAGES IN A DUAL ENGINE SYSTEM.”

### FIELD OF THE INVENTION

This invention relates to printing on a plurality of print engines comprising at least one digital print whereby the images printed on the plurality of print engines are printed on a single receiver sheet.

### BACKGROUND OF THE INVENTION

In typical commercial reproduction apparatus (electrographic copier/duplicators, printers, or the like), a latent image charge pattern is formed on a primary imaging member (PIK) such as a photoreceptor used in an electrophotographic printing apparatus. While the latent image can be formed on a dielectric PIM by depositing charge directly corresponding to the latent image, it is more common to first uniformly charge a photoreceptive PIM member. The latent image is then formed by area-wise exposing the PIM in a manner corresponding to the image to be printed. The latent image is rendered visible by bringing the primary imaging member into close proximity to a development station. A typical development station may include a cylindrical magnetic core and a coaxial nonmagnetic shell. In addition, a sump may be present containing developer which includes marking particles, typically including a colorant such as a pigment, a thermoplastic binder, one or more charge control agents, and flow and transfer aids such as submicrometer particles adhered to the surface of the marking particles. The submicrometer particles typically include silica, titania, various lattices, etc. The developer also typically includes magnetic carrier particles such as ferrite particles that tribocharge the marking particles and transport the marking particles into close proximity to the PIM, thereby allowing the marking particles to be attracted to the electrostatic charge pattern corresponding to the latent image on the PIM, thereby rendering the latent image into a visible image.

The shell of the development station is typically electrically conducting and can be electrically biased so as to establish a desired difference of potential between the shell and the PIM. This, together with the electrical charge on the marking particles, determines the maximum density of the developed print for a given type of marking particle.

The image developed onto the PIM member is then transferred to a suitable receiver such as paper or other substrate. This is generally accomplished by pressing the receiver into contact with the PIM member while applying a potential difference (voltage) to urge the marking particles towards the receiver. Alternatively, the image can be transferred from the primary imaging member to a transfer intermediate member (TIM) and then from the TIM to the receiver.

The image is then fixed to the receiver by fusing, typically accomplished by subjecting the image bearing receiver to a combination of heat and pressure. The PIM and TIM, if used, are cleaned and made ready for the formation of another print.

A printing engine generally is designed to generate a specific number of prints per minute. For example, a printer may be able to generate 150 single-sided pages per minute (ppm) or approximately 75 double-sided pages per minute with an appropriate duplexing technology. Small upgrades in system throughput may be achievable in robust printing systems. However, the doubling of throughput speed is mainly unachievable without a) purchasing a second reproduction apparatus with throughput identical to the first so that the two machines may be run in parallel, or without b) replacing the first reproduction apparatus with a radically redesigned print engine having double the speed. Both options are very expensive and often with regard to option (b), not possible.

Another option for increasing printing engine throughput is to utilize a second print engine in series with a first print engine. For example, U.S. Pat. No. 7,245,856 discloses a tandem print engine assembly which is configured to reduce image registration errors between a first side image formed by a first print engine, and a second side image formed by a second print engine. Each of the '856 print engines has a seamed photoreceptive belt. The seams of the photoreceptive belt in each print engine are synchronized by tracking a phase difference between seam signals from both belts. Synchronization of a slave print engine to a main print engine occurs once per revolution of the belts, as triggered by a belt seam signal, and the speed of the slave photoreceptor and the speed of an imager motor and polygon assembly are updated to match the speed of the master photoreceptor. Unfortunately, such a system tends to be susceptible to increasing registration errors during each successive image frame during the photoreceptor revolution. Furthermore, given the large inertia of the high-speed rotating polygon assembly, it is difficult to make significant adjustments to the speed of the polygon assembly in the relatively short time frame of a single photoreceptor revolution. This can limit the response of the '856 system on a per revolution basis, and make it even more difficult, if not impossible, to adjust on a more frequent basis.

Color images are made by printing separate images corresponding to an image of a specific color. The separate images are then transferred, in register, to the receiver. Alternatively, they can be transferred in register to a TIM and from the TIM to the receiver or they may be transferred separately to a TIM and then transferred and registered on the receiver. For example, a printing engine assembly capable of producing full color images may include at least four separate print engines or modules where each module or engine prints one color corresponding to the subtractive primary color cyan, magenta, yellow, and black. Additional development modules may include marking particles of additional colorants to expand the obtainable color gamut, clear toner, etc., as are known in the art. The quality of images produced on different print engines can be found to be objectionable if produced on different print engines even if the print engines are nominally the same, e.g. the same model produced by the same manufacturer. For example, the images can have slightly different sizes, densities or contrasts. These variations, even if small, can be quite noticeable if the images are compared closely.

It is clearly important that certain image quality attributes, including size, print density, and contrast, match for prints made on separate print engines if those prints are subject to close scrutiny, as would be the case when a print made on a receiver sheet is produced on separate print engines. Specifically, the reflection density and the contrast of the prints need to closely match or the prints will be found to be objectionable to a customer. Even prints produced on two nominally identical digital printing presses such as electrophotographic printing presses described herein can vary in density and contrast due to variations in the photo-response of the PIM, variations in the charge or size of the marking particles, colorant dispersion variations within the batches of marking particles used in the separate engines, etc. It is clear that a method is needed to allow comparable prints to be produced on a plurality of engines.

### SUMMARY OF THE INVENTION

This invention is a method of adjusting the size of images produced on separate printing engines, particularly coupled digital printing engines such as one with at least one electrophotographic print module. The method minimizes the difference in the printed image size by selecting matched printer components for certain critical elements within the coupled print engines in order to take into account the differences in the physically coupled print engines.

### BRIEF DESCRIPTION OF THE DRAWINGS

FIG. 1 schematically illustrates an electrophotographic print engine.

FIG. 2 schematically illustrates an a reproduction apparatus having a first print engine.

FIGS. 3A-3C schematically illustrate a reproduction apparatus having a first print engine and a tandem second print engine from a productivity module.

FIG. 4 schematically illustrates a reproduction or printing apparatus having embodiments of a first and second print engines.

FIG. 5 shows an embodiment of a receiver having fiducial marks printed on a print engine.

FIG. 6 shows another embodiment of a receiver having fiducial marks printed on a print engine.

FIG. 7 shows another embodiment of a receiver having fiducial marks printed on a print engine.

FIG. 8 shows another embodiment of a receiver having fiducial marks printed on a print engine.

It will be appreciated that for purposes of clarity and where deemed appropriate, reference numerals have been repeated in the figures to indicate corresponding features, and that the various elements in the drawings have not necessarily been drawn to scale in order to better show the features.

### DETAILED DESCRIPTION OF THE MENTION

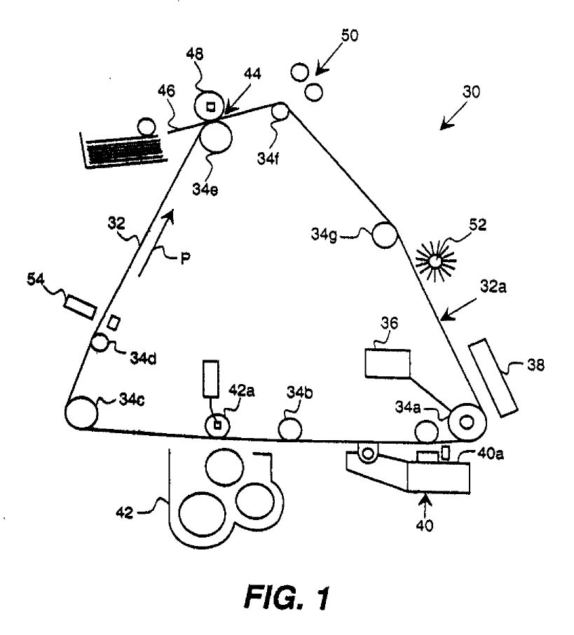

FIG. 1 schematically illustrates an embodiment of an electrophotographic print engine 30. The print engine 30 has a movable recording member such as a photoreceptive belt 32, which is entrained about a plurality of rollers or other supports 34a through 34g. The photoreceptive belt 32 may be more generally referred-to as a primary imaging member (PIM) 32. A primary imaging member (PIM) 32 may be any charge carrying substrate which may be selectively charged or discharged by a variety of methods including, but not limited to corona charging/discharging, gated corona charging/discharging, charge roller charging/discharging, ion writer charging, light discharging, heat discharging, and time discharging.

One or more of the rollers 34a-34g are driven by a motor 36 to advance the PIM 32. Motor 36 preferably advances the PIM 32 at a high speed, such as 20 inches per second or higher, in the direction indicated by arrow P, past a series of workstations of the print engine 30, although other operating speeds may be used, depending on the embodiment. In some embodiments, PIM 32 may be wrapped and secured about a single drum. In further embodiments, PIM 32 may be coated onto or integral with a drum.

It is useful to define a few terms that are used in relation to this invention. Optical density is the log of the ratio of the intensity of the input illumination to the transmitted, reflected, or scattered light, or D=log(Iᵢ/Iₒ) where D is the optical density, I_{I} is the intensity of the input illumination, Iₒ is the intensity of the output illumination, and log is the logarithm to the base 10. Thus, an optical density of 0.3 means that the output intensity is approximately half of the input intensity which is desirable for quality prints.

For some applications, it is preferable to measure the intensity of the light transmitted through a sample such as a printed image. This is referred to as the transmission density and is measured by first nulling out the density of the substrate supporting the image and then measuring the density of the chosen region of the image by illuminating the image through the back of the substrate with a known intensity of light and measuring the intensity of the light transmitted through the sample. The color of the light chosen corresponds to the color of the light principally absorbed by the sample. For example, if the sample consists of a printed black region, white light would be used. If the sample was printed using the subtractive primary colors (cyan, magenta, or yellow), red, green, or blue light, respectively, would be used.

Alternatively, it is sometimes preferable to measure the light reflected or scattered from a sample such as a printed image. This is referred to as the reflection density. This is accomplished by measuring the intensity of the light reflected from a sample such as a printed image after nulling out the reflection density of the support. The color of the light chosen corresponds to the color of the light principally absorbed by the sample. For example, if the sample consists of a printed black region, white light would be used. If the sample was printed using the subtractive primary colors (cyan, magenta, or yellow), cyan, magenta, or yellow light, respectively, would be used.

A suitable device for measuring optical density is an X-Rite densitometer with status A filters. Some such devices measure either transmission or reflected light. Other devices measure both transmission and/or reflection densities. Alternatively, for use within a printing engine, densitometers such as those described by Rushing in U.S. Pat. Nos. 6,567,171, 6,144,024, 6,222,176, 6,225,618, 6,229,972, 6,331,832, 6,671,052, and 6,791,485 are well suited. Other densitometers, as are known in the art, are also suitable.

The size of the sample area required for densitometry measurements varies, depending on a number of factors such as the size of the aperture of the densitometer and the information desired. For example, microdensitomers are used to measure site-to-site variations in density of an image on a very small scale to allow the granularity of an image to be measured by determining the standard deviation of the density of an area having a nominally uniform density. Alternatively, densitometers also are used having an aperture area of several square centimeters. These allow low frequency variations in density to be determined using a single measurement. This allows image mottle to be determined. For simple determinations of image density, the area to be measured generally has a radius of at least 1 mm but not more than 5 mm.

The term module means a device or subsystem designed to perform a specific task in producing a printed image. For example, a development module in an electrophotographic printer would include a primary imaging member (PIM) such as a photoreceptive member and one or more development stations that would image-wise deposit marking or toner particles onto an electrostatic latent image on the PIM, thereby rendering it into a visible image. A module can be an integral component in a print engine. For example, a development module is usually a component of a larger assembly that includes writing transfer and fuser modules such as are known in the art. Alternatively, a module can be self contained and can be made in a manner so that they are attached to other modules to produce a print engine. Examples of such modules include scanners, glossers, inverters that will invert a sheet of paper or other receiver to allow duplex printing, inserters that allow sheets such as covers or preprinted receivers to be inserted into documents being printed at specific locations within a stack of printed receiver sheets, and finishers that can fold, stable, glue, etc. the printed documents.

A print engine includes sufficient modules to produce prints. For example, a black and white electrophotographic print engine would generally include at least one development module, a writer module, and a fuser module. Scanner and finishing modules can also be included if called for by the intended applications.

A print engine assembly, also referred to in the literature as a reproduction apparatus, includes a plurality of print engines that have been integrally coupled together in a manner to allow them to print in a desired manner. For example, print engine assemblies that include two print engines and an inverter module that are coupled together to increase productivity by allowing the first print engine to print on one side of a receiver, the receiver then fed into the inverter module which inverts the receiver and feeds the receiver into the second print engine that prints on the inverse side of the receiver, thereby printing a duplex image.

A digital print engine is a print engine wherein the image is written using digital electronics. Such print engines allow the image to be manipulated, image by image, thereby allowing each image to be changed. In contrast, an offset press relies on the image being printed using press plates. Once the press plate is made, it cannot be changed. An example of a digital print engine is an electrophotographic print engine wherein the electrostatic latent image is formed on the PIM by exposing the PIM using a laser scanner or LED array. Conversely, an electrophotographic apparatus that relies on forming a latent image by using a flash exposure to copy an original document would not be considered a digital print engine.

A digital print engine assembly is a print engine assembly that includes a plurality of print engines of which at least one is a digital print engine.

Contrast is defined as the maximum value of the slope curve of the density versus log of the exposure. The contrast of two prints is considered to be equal if they differ by less than 0.2 ergs/cm² and preferably by less than 0.1 ergs/cm².

Print engine 30 may include a controller or logic and control unit (LCU) (not shown). The LCU may be a computer, microprocessor, application specific integrated circuit (ASIC), digital circuitry, analog circuitry, or a combination or plurality thereof. The controller (LCU) may be operated according to a stored program for actuating the workstations within print engine 30, effecting overall control of print engine 30 and its various subsystems. The LCU may also be programmed to provide closed-loop control of the print engine 30 in response to signals from various sensors and encoders. Aspects of process control are described in U.S. Pat. No. 6,121,986 incorporated herein by this reference.

A primary charging station 38 in print engine 30 sensitizes PIM 32 by applying a uniform electrostatic corona charge, from high-voltage charging wires at a predetermined primary voltage, to a surface 32a of PIM 32. The output of charging station 38 may be regulated by a programmable voltage controller (not shown), which may in turn be controlled by the LCU to adjust this primary voltage, for example by controlling the electrical potential of a grid and thus controlling movement of the corona charge. Other forms of chargers, including brush or roller chargers, may also be used.

An image writer, such as exposure station 40 in print engine 30, projects light from a writer 40a to PIM 32. This light selectively dissipates the electrostatic charge on photoreceptive PIM 32 to form a latent electrostatic image of the document to be copied or printed. Writer 40a is preferably constructed as an array of light emitting diodes (LEDs), or alternatively as another light source such as a Laser or spatial light modulator. Writer 40a exposes individual picture elements (pixels) of PIM 32 with light at a regulated intensity and exposure, in the manner described below. The exposing light discharges selected pixel locations of the photoreceptor, so that the pattern of localized voltages across the photoreceptor corresponds to the image to be printed. An image is a pattern of physical light, which may include characters, words, text, and other features such as graphics, photos, etc. An image may be included in a set of one or more images, such as in images of the pages of a document. An image may be divided into segments, objects, or structures each of which is itself an image. A segment, object or structure of an image may be of any size up to and including the whole image.

After exposure, the portion of PIM 32 bearing the latent charge images travels to a development station 42. Development station 42 includes a magnetic brush in juxtaposition to the PIM 32. Magnetic brush development stations are well known in the art, and are desirable in many applications; alternatively, other known types of development stations or devices may be used. Plural development stations 42 may be provided for developing images in plural gray scales, colors, or from toners of different physical characteristics. Full process color electrographic printing is accomplished by utilizing this process for each of four toner colors (e.g., black, cyan, magenta, yellow).

Upon the imaged portion of PIM 32 reaching development station 42, the LCU selectively activates development station 42 to apply toner to PIM 32 by moving backup roller 42a and PIM 32, into engagement with or close proximity to the magnetic brush. Alternatively, the magnetic brush may be moved toward PIM 32 to selectively engage PIM 32. In either case, charged toner particles on the magnetic brush are selectively attracted to the latent image patterns present on PIM 32, developing those image patterns. As the exposed photoreceptor passes the developing station, toner is attracted to pixel locations of the photoreceptor and as a result, a pattern of toner corresponding to the image to be printed appears on the photoreceptor. As known in the art, conductor portions of development station 42, such as conductive applicator cylinders, are biased to act as electrodes. The electrodes are connected to a variable supply voltage, which is regulated by a programmable controller in response to the LCU, by way of which the development process is controlled.

Development station 42 may contain a two-component developer mix, which includes a dry mixture of toner and carrier particles. Typically the carrier preferably includes high coercivity (hard magnetic) fernite particles. As a non-limiting example, the carrier particles may have a volume-weighted diameter of approximately 30μ. The dry toner particles are substantially smaller, on the order of 6μ to 15μ in volume-weighted diameter. Development station 42 may include an applicator having a rotatable magnetic core within a shell, which also may be rotatably driven by a motor or other suitable driving means. Relative rotation of the core and shell moves the developer through a development zone in the presence of an electrical field. In the course of development, the toner selectively electrostatically adheres to PIM 32 to develop the electrostatic images thereon and the carrier material remains at development station 42. As toner is depleted from the development station due to the development of the electrostatic image, additional toner may be periodically introduced by a toner auger (not shown) into development station 42 to be mixed with the carrier particles to maintain a uniform amount of development mixture. This development mixture is controlled in accordance with various development control processes. Single component developer stations, as well as conventional liquid toner development stations, may also be used.

A transfer station 44 in printing machine 10 moves a receiver sheet 46 into engagement with the PIM 32, in registration with a developed image to transfer the developed image to receiver sheet 46. Receiver sheets 46 may be plain or coated paper, plastic, or another medium capable of being handled by the print engine 30. Typically, transfer station 44 includes a charging device for electrostatically biasing movement of the toner particles from PIM 32 to receiver sheet 46. In this example, the biasing device is roller 48, which engages the back of sheet 46 and which may be connected to a programmable voltage controller that operates in a constant current mode during transfer. Alternatively, an intermediate member may have the image transferred to it and the image may then be transferred to receiver sheet 46. After transfer of the toner image to receiver sheet 46, sheet 46 is detached from PIM 32 and transported to fuser station 50 where the image is fixed onto sheet 46, typically by the application of heat and/or pressure. Alternatively, the image may be fixed to sheet 46 at the time of transfer. A cleaning station 52, such as a brush, blade, or web is also located beyond transfer station 44, and removes residual toner from PIM 32. A pre-clean charger (not shown) may be located before or at cleaning station 52 to assist in this cleaning. After cleaning, this portion of PIM 32 is then ready for recharging and re-exposure. Of course, other portions of PIM 32 are simultaneously located at the various workstations of print engine 30, so that the printing process may be carried out in a substantially continuous manner.

A controller provides overall control of the apparatus and its various subsystems with the assistance of one or more sensors, which may be used to gather control process, input data. One example of a sensor is belt position sensor 54.

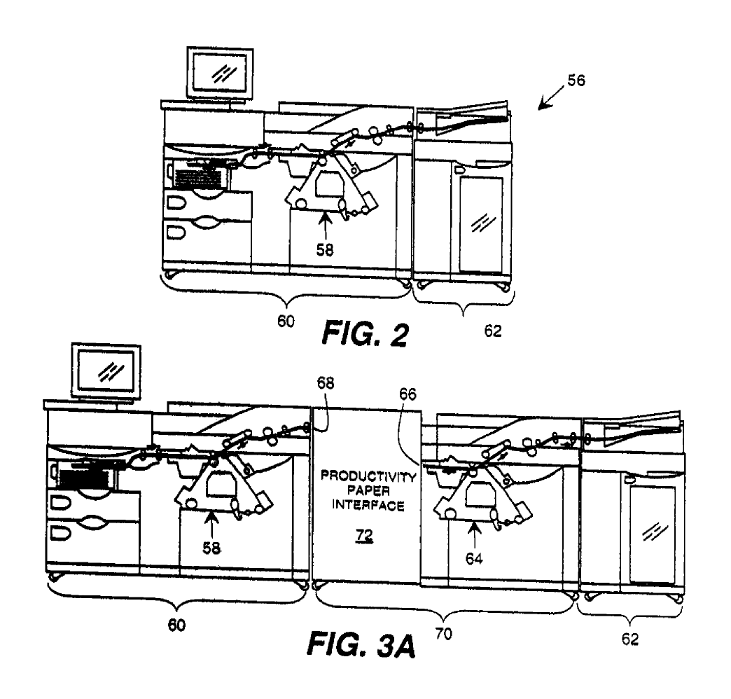

FIG. 2 schematically illustrates an embodiment of a reproduction apparatus 56 having a first print engine 58 that is capable of printing one or a multiple of colors. The embodied reproduction apparatus will have a particular throughput, which may be measured in pages per minute (ppm). As explained above, it would be desirable to be able to significantly increase the throughput of such a reproduction apparatus 56 without having to purchase an entire second reproduction apparatus. It would also be desirable to increase the throughput of reproduction apparatus 56 without having to scrap apparatus 56 and replacing it with an entire new machine.

Quite often, reproduction apparatus 56 is made up of modular components. For example, the print engine 58 is housed within a main cabinet 60 that is coupled to a finishing unit 62. For simplicity, only a single finishing device 62 is shown, however, it should be understood that multiple finishing devices providing a variety of finishing functionality are known to those skilled in the art and may be used in place of a single finishing device. Depending on its configuration, the finishing device 62 may provide stapling, hole punching, trimming, cutting, slicing, stacking, paper insertion, collation, sorting, and binding.

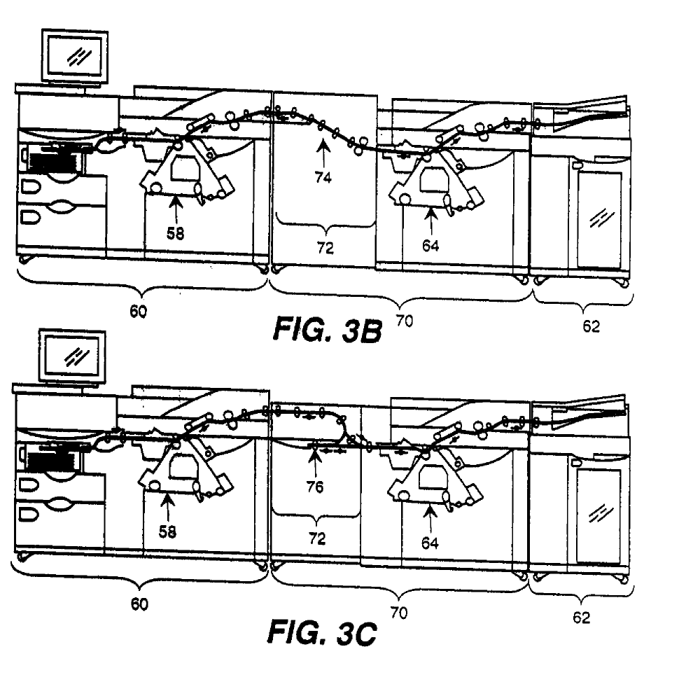

As FIG. 3A schematically illustrates, a second print engine 64 may be inserted in-line with the first print engine 58 and in-between the first print engine 58 and the finishing device 62 formerly coupled to the first print engine 58. The second print engine 64 may have an input paper path point 66 which does not align with the output paper path point 68 from the first print engine 58. Additionally, or optionally, it may be desirable to invert the receiver sheets from the first print engine 58 prior to running them through the second print engine (in the case of duplex prints). In such instances, the productivity module 70 which is inserted between the first print engine 58 and the at least one finisher 62 may have a productivity paper interface 72. Some embodiments of a productivity paper interface 72 may provide for matching 74 of differing output and input paper heights, as illustrated in the embodiment of FIG. 3B. Other embodiments of a productivity paper interface 72 may provide for inversion 76 of receiver sheets, as illustrated in the embodiment of FIG. 3C.

Providing users with the option to re-use their existing equipment by inserting a productivity module 70 between their first print engine 58 and their one or more finishing devices 62 can be economically attractive since the second print engine 64 of the productivity module 70 does not need to come equipped S with the input paper handling drawers coupled to the first print engine 58. Furthermore, the second print engine 64 can be based on the existing technology of the first print engine 58 with control modifications which will be described in more detail below to facilitate synchronization between the first and second print engines.

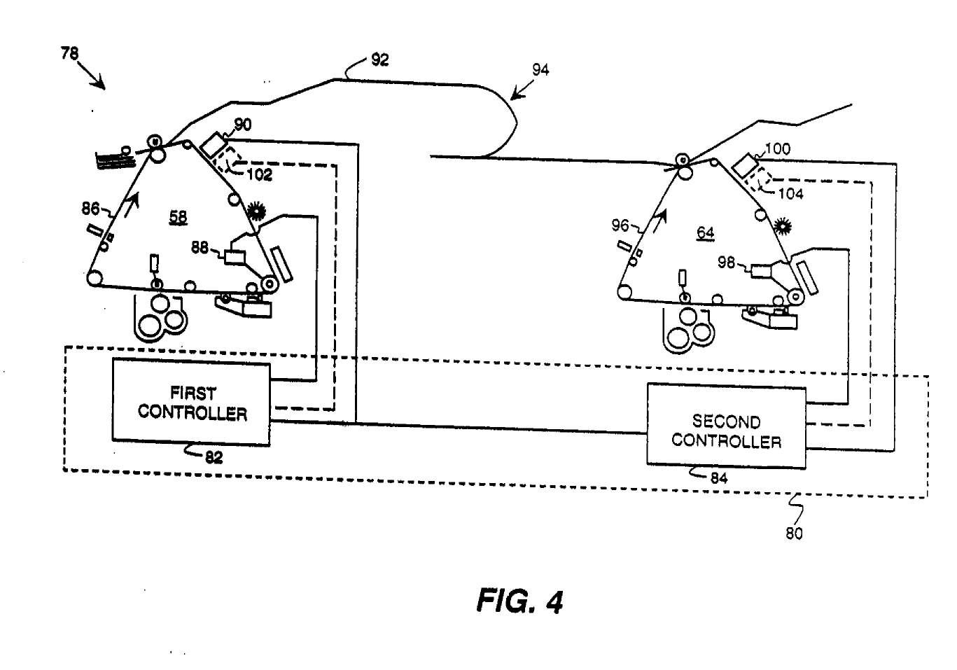

FIG. 4 schematically illustrates an embodiment of a reproduction apparatus 78 having first and second print engines 58, 64 which are synchronized by a controller 80. Controller 80 may be a computer, a microprocessor, an application specific integrated circuit, digital circuitry, analog circuitry, or any combination and/or plurality thereof In this embodiment, the controller 80 includes a first controller 82 and a second controller 84. Optionally, in other embodiments, the controller 80 could be a single controller as indicated by the dashed line for controller 80. The first print engine 58 has a first primary imaging member (PIM) 86, the features of which have been discussed above with regard to the PIM of FIG. 1. The first PIM 86 also preferably has a plurality of frame markers corresponding to a plurality of frames on the PIM 86. In some embodiments, the frame markers may be holes or perforations in the PIM 86 which an optical sensor can detect. In other embodiments, the frame markers may be reflective or diffuse areas on the PIM, which an optical sensor can detect. Other types of frame markers will be apparent to those skilled in the art and are intended to be included within the scope of this specification. The first print engine 58 also has a first motor 88 coupled to the first PIM 86 for moving the first PIM when enabled. As used here, the term “enabled” refers to embodiments where the first motor 88 may be dialed in to one or more desired speeds as opposed to just an on/off operation. Other embodiments, however, may selectively enable the first motor 88 in an on/off fashion or in a pulse-width-modulation fashion.

The first controller 82 is coupled to the first motor 88 and is configured to selectively enable the first motor 88 (for example, by setting the motor for a desired speed, by turning the motor on, and/or by pulse-width-modulating an input to the motor). A first frame sensor 90 is also coupled to the first controller 82 and configured to provide a first frame signal, based on the first PIM's plurality of frame markers, to the first controller 82.

A second print engine 64 is coupled to the first print engine 58, in this embodiment, by a paper path 92 having an inverter 94. The second print engine 64 has a second primary imaging member (PIM) 96, the features of which have been discussed above with regard to the PIM of FIG. 1. The second PIM 96 also preferably has a plurality of frame markers corresponding to a plurality of frames on the PIM 96. In some embodiments, the frame markers may be holes or perforations in the PIM 96, which an optical sensor can detect. In other embodiments, the frame markers may be reflective or diff-use areas on the PIM which an optical sensor can detect. Other types of frame markers will be apparent to those skilled in the art and are intended to be included within the scope of this specification. The second print engine 64 also has a second motor 98 coupled to the second PIM 96 for moving the second PIM 96 when enabled. As used here, the term “enabled” refers to embodiments where the second motor 98 may be dialed in to one or more desired speeds as opposed to just an on/off operation. Other embodiments, however, may selectively enable the second motor 98 in a pulse-width-modulation fashion.

The second controller 84 is coupled to the second motor 98 and is configured to selectively enable the second motor 98 (for example, by setting the motor for a desired speed, or by pulse-width-modulating an input to the motor). A second frame sensor 100 is also coupled to the second controller 84 and configured to provide a second frame signal, based on the second PIM's plurality of frame markers, to the second controller 84. The second controller 84 is also coupled to the first frame sensor 90 either directly as illustrated or indirectly via the first controller 82 which may be configured to pass data from the first frame sensor 90 to the second controller 84.

While the operation of each individual print engine 58 and 64 has been described on its own, the second controller 84 is also configured to synchronize the first and second print engines 58, 64 on a frame-by-frame basis. Optionally, the second controller 84 may also be configured to synchronize a first PIM splice seam from the first PIM 86 with a second PIM splice seam from the second PIM 96. In the embodiments that synchronize the PIM splice seams, the first print engine 58 may have a first splice sensor 102 and the second print engine 64 may have a second splice sensor 104. In other embodiments, the frame sensors 90, 100 may be configured to double as splice sensors.

It should be noted that the preceding discussion discloses a preferred embodiment of practicing this invention. It is obvious to one schooled in the art that variations of the aforementioned discussion fall within the scope of this invention.

For use in this disclosure, the term “in track” refers to the principal direction in which the receiver sheet travels during processing. The term “cross-track” refers to the direction perpendicular to the principal direction that the receiver sheet travels. “Principal direction” refers to the general direction in which the receiver sheet travels. Accordingly, in most digital print engines, the principal direction is approximately horizontal, even though the receiver sheet may be turned or rotated so that for a short time it may be travelling in a vertical or other direction. Obviously, the principal direction can vary from one digital print engine to another, depending on the specific design of that engine.

In a dual engine printer it is necessary to match the print sizes by effectively compensating for variations in the in track and cross track directions. Print sizes in the in track and cross track directions can differ due to variations in the size and make up of critical parameters of components such as the photoreceptor, speed or encoder variations, etc. Even minor process variations such as the fuser temperature or thermal conductivity of two EP print modules can change the size of paper receivers. Indeed, the fuser in the first print engine can shrink the receiver bearing the first image, resulting in the second print engine receiving an image whose size differs from the nominal settings. Shrinkage of a paper receiver can differ in the in track and cross track directions due to the physical properties of the paper. Accordingly, it is preferable to be able to adjust the image size for in track and cross track image size independently.

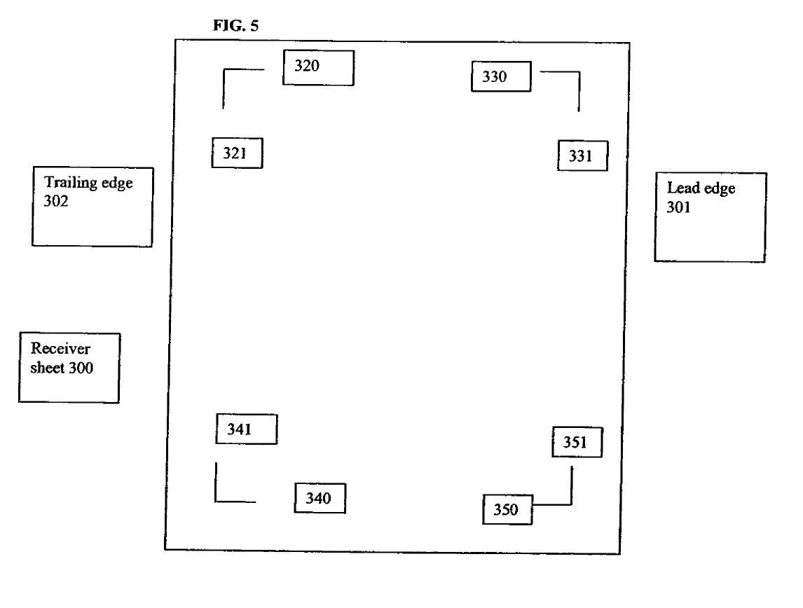

FIG. 5 shows one test pattern showing fiducial marks near each corner. While the specific fiducial marks show pairs of orthogonal lines, this is not necessary in practice. In one method of adjusting a sheet size the receiver sheet shown, printed on a digital print engine, is compared with a similar pattern printed on a second print engine, which may or may not be digital and may or may not be coupled to the first print engine. The separations between markings corresponding pairs of marks such as 321 and 331 or 320 and 340 are measured for a receiver sheet printed on each engine. Length variations are corrected on the digital print engine by using one of three methods, depending on whether the corrections needed are in the cross track or in track directions. For printers utilizing an LED array, cross track size adjustments can be made by altering the pitch of the LED array, which may be accomplished by selecting a writer with a specific pitch. For printers utilizing an Laser, cross track size adjustments are known to those skilled in the art by methods such as altering the laser scan modulation as in changing speed of the polygon. A second approach would be to use the raster imaging processor (RIP) to scale the image as required to size the image in engine 1 to match that of engine 2 for either in track or cross track directions. By adjusting the RIP, adjustments for variations in in track and cross track directions can be made independently of each other. A third approach would be to use a higher resolution encoder such that each print line has multiple encoders in between. With sufficient resolution, the number of encoder pulse between print lines could be adjusted to compensate for mechanical tolerance between the engines. In one method this would be at least 10 encoder pulses between print lines. This approach has the disadvantage of higher cost and complexity. This approach does not compensate for cross track variations. Alternately this can be done with only 3 sets of marks as long as distortions are linear.

The marks can be read directly from prints made from the engines being matched. For example, separate prints of the same test target containing the fiducial marks can be measured using an appropriate device such as a ruler, digital scanner or digitizing tablet that records the relative positions of the marks. The timing of the digital print engine can then be adjusted so that the marks are equally spaced on subsequent prints made on each print engine.

Alternatively, the position of fiducial marks on either the PIMs or receiver sheets can be determined within each print engine. This can be done by multiplying the time between the marks in each print engine and the speed of each PIM. The time between marks can be measured using densitometers. The speed of the PIMs can be calculated based on the time between frame markers and a measure of drive speed, such as an encoder on each PIM drive roller or motor. Once the position of the fiducial marks is known, adjustments including, but not limited to, those defined above, can be to compensate for differences. This can be done directly for in-track corrections. Moreover, based on the differences measured, one can determine the source for the variation. If the speeds of the PIMs are different, they must be different in size since the speed control algorithm adjusts the speed of the engines to achieve the same time between frame markers. If the speeds of the PIMs are essentially the same, the variation is due to a drive component, such as the drive roller, or the paper shrinkage. Since the vast majority of the receiver shrinkage occurs during the first fusing process, comparing the length of the receiver before and after printing can isolate the paper shrinkage contribution from the drive component contribution. For cross-track corrections, the densitometer can scan across the PIMs or the receiver sheets and the time between detecting the first and second fiducials used to correct the image scaling. Alternatively, several densitometers can be used to locate the positions of the fiducials. In yet another alternative, the densitometers can be rotated about an axis that would allow the densitometers to scan in the cross-track direction. The position of the fiducial marks would then be determined from the angle of the densitometer relative to the PIM or the receiver sheet.

In an alternative method, the fiducial marks can include electrostatic latent image fiducials. In this instance, the position of the marks on each of the print engines can be determined using an electrostatic volt meter, with the in-track and cross-track electrostatic latent image fiducial marks being measured using analogous methods to those described for measuring actual fiducials with densitometers.

In yet another method, the position of fiducial marks on the PIMs can be tracked using encoders and the writer can then be adjusted so that prints made on each engine is the same size as those made on the other engines.

It is possible to save the determined scalings required to match in-track and cross-track image sizes in the processing unit of the digital print engine. The appropriate scalings can then be recalled and the digital print engine set up to produce images with the correct sizes. For methods that measure the fiducials on the receiver after the image has been fused, such storage could be done for each receiver type, including variations in the types of paper used, the weight of the paper, etc. It would still be necessary to set the appropriate image scaling when a major component such as a fuser member, PIM, etc. is changed or if process conditions such as the moisture content of the receiver, the fuser temperature, etc. are changed.

In an alternative method, a fiducial mark is printed by the first print engine at one location of the receiver. A second set of fiducial marks is printed by the first print engine along the process direction of the same receiver. The second set consists of a series of parallel lines (approximately 10) that are closely spaced (approximately 1 mm apart). Another set of two individual fiducial marks is printed by the second print engine, preferably on a second receiver sheet. The receiver sheets are then positioned so that the first fiducial marks are in alignment. The second set of fiducial marks then forms a vernier similar to that on micrometers and vernier calipers and the magnification of the image produced by the digital print engine is then adjusted according to the scaling obtained on the vernier.

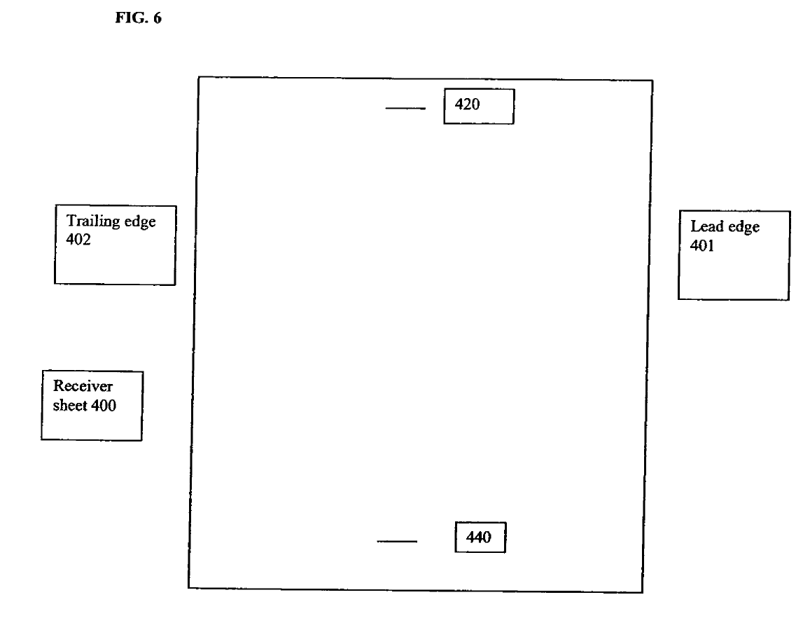

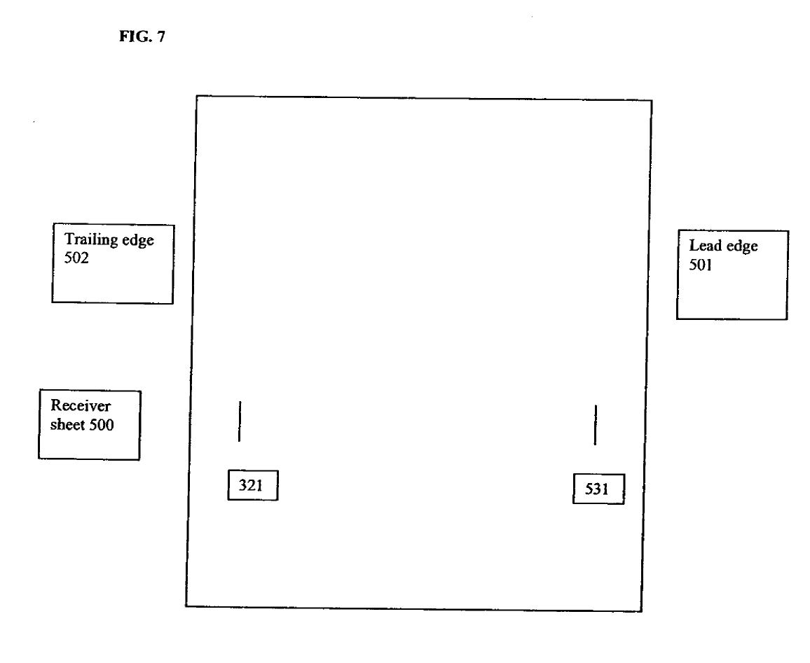

Alternative prints suitable for cross track and in track only measurements are shown in FIGS. 6 and 7, respectively. While using these types of prints are less preferred, they may be suitable if both modes or correction are either unwarranted or cannot be done.

Although FIGS. 5-8 show suitable fiducial marks for this use, it is recognized that other distinguishing marks on prints may also be suitable. Such marks should be relatively small and well defined.

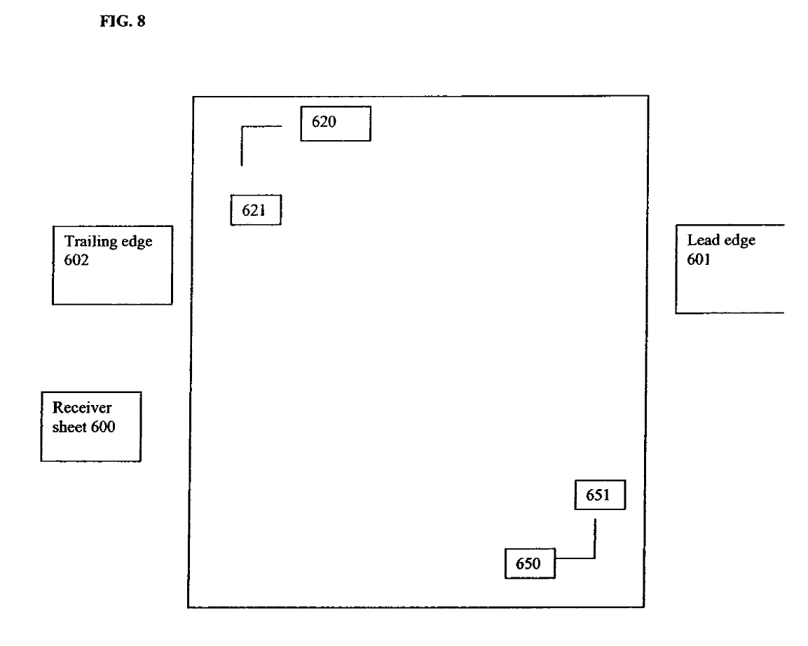

An alternative print suitable for determining both in track and cross track variations in size is shown in FIG. 8. In this case the length of the line connecting the vertices of the pairs of fiducial lines is measured for prints from each print engine. The necessary in track and cross track corrections can then determined from the length of this line by using simple trigonometry. Although it is preferable to use the same digital file to produce the test prints on all print engines, it is recognized that this is not always feasible. In such instances, a print from one engine can be digitized using known technology such as a scanner and the second print engine can produce a print from the print produced on the first print engine. To minimize errors introduced in this manner, it is worthwhile to verify that the prints produced on both print engines are the same size, as often can be determined from registering superimposed prints and other means known in the art.

The image writer is exposure station 40 in print engine 30 shown in FIG. 1 and projects light from a writer 40a to PIM 32. In one embodiment of this invention, each of the image writers for all of the print engines in the coupled print engines are chosen as a matched set, with the pitch of the LEDs matched as closely as possible to each other. By selecting matched sets, the crosstrack size uniformity within the coupled print engines will be much better than if writers selected randomly from the population of writers would yield. This is less costly than to manufacture all writers in the population to be within a similar tolerance. Each writer could be characterized into sub-groups, or bins, based on the measured pitch of the LEDs. Using this information, if an additional print engine were to be added to a print engine (or coupled print engines) already at a customer site, a writer could be selected to match the existing writer(s), alleviating the need to replace them. Similarly, should a writer in a coupled print engine fail, a replacement from the same bin could be used as the replacement. It is understood to those skilled in the art that other writers, such as a laser writer could also be part of a matched pair and in fact the matched pair could include two different components if together they worked in such a way to compensate for the others actions.

In another embodiment critical drive components that affect intrack size, such as the plurality of rollers and/or supports 34a through 34g could be treated in the same way and used as matched components. In one embodiment, the photoconductor drive rollers are divided into sub groups or bins based on the diameter which is one of a range of critical roller parameters. Others critical parameters could include roller materials, temperature ranges or state, thermal conductivity and other characteristics that can be matched and would affect the print. All the coupled print engines would then use rollers from the same bin. Other critical components besides a drive roller that could be matched as a matched component in include primary imaging members, and intermediate transfer members in some types of printers.

In one embodiment, the sets could be matched to compensate for target receiver shrinkage in the intrack and/or crosstrack direction. The target receiver shrinkage may be the average or median receiver shrinkage for a typical class of receivers or a specific receiver under specified conditions. For instance, if the diameter of the photoconductor drive roller for the first coupled engine was selected to be larger than the rollers for the other coupled engines by the percentage of the median receiver shrinkage, the maximum intrack size error would be half as large as if all rollers were the same size. Alternatively, if a customer generally used the same receiver and the operating conditions were controlled, the receiver shrinkage could be measured and the rollers could be selected accordingly. The writer could be treated in the same fashion to compensate for target crosstrack receiver shrinkage.

These embodiments show the strength of this invention which works well to situations that require a target or average correction like a target or average size variation such as receiver shrinkage. This method adds robustness to the printer system without having to make additional changes. It is easy to enable in all printer systems.

While these embodiments describe specific critical components that could be used to effect size variations, the concept is not limited to these specific components. It could be applied to other areas such as overdrives and encoders.

In another embodiment of this method for minimizing the difference in printed image size in a plurality of physically coupled print engines two or more matched components are grouped such that the matched components have an incremental difference in one or more critical parameters to compensate for a target receiver shrinkage and the matched printer components are selected for the critical parameters for each print engine within a plurality of coupled print engines so that the matched components compensate for a target receiver shrinkage. The matched printer components for all of the print engines in the coupled print engines are chosen from a matched set, such as that of encoders having a critical parameter including line frequency.

Accordingly, this invention describes a method for making images employing a plurality of print engines whereby at least some of the print engines after the first print engine produces images using digital means and whereby the magnification of the separate images formed on one or more of the digital print engines is adjusted for size by selecting matched printer components for certain critical components within the coupled print engines in order to minimize the differences in a printed image size in the physically coupled print engines. This can be done in conjunction with other corrective methods such as printing a first image using a print engine using an original file or document comprising at least two fiducial marks, measuring the separation of the fiducial marks, printing a second image comprising fiducial marks on a second print engine comprising a digital print engine, and adjusting the writer on the digital print engine so that the space between the fiducial marks on each of the prints is matched. The size of a print produced on each print engine is determined by comparing the distance between the printed fiducial marks to the distance between the fiducial marks on the original file or document. Note that the image printed on the second print engine is the print printed on the first print engine.

The invention has been described in detail with particular reference to certain preferred embodiments thereof, but it will be understood that variations and modifications can be effected within the spirit and scope of the invention.

What is claimed is:

1. A method for minimizing the difference in printed image size in a plurality of physically coupled print engines comprising selecting matched printer components based on one or more critical parameters for each print engine within a plurality of coupled print engines.

2. The method according to claim 1 whereby the size of a print produced on each print engine is determined by comparing a distance between two or more printed fiducial marks to a distance between two or more fiducial marks on the original file.

3. The method according to claim 1 whereby the matched printer components for all of the print engines in the coupled print engines are chosen from a matched set of the image writers.

4. The method according to claim 3 wherein the matched set of the image writers are chosen from binned sub-groups based on the measured pitch of the LEDs.

5. The method according to claim 1 whereby the matched printer components comprise critical drive components that affect intrack size.

6. The method according to claim 5 wherein the matched set of are chosen from binned sub-groups of rollers based on a critical parameter.

7. The method according to claim 6 wherein the critical parameter is one or more of roller diameter, roller material, temperature, and thermal conductivity.

8. The method according to claim 1 whereby the matched printer components comprise one or more of a primary imaging member and an intermediate transfer member.

9. The method according to claim 1 further comprising:
printing a first image as a first print using a print engine to locate at least two first fiducial marks related to an original document;
measuring a separation of the at least two first fiducial marks on the first print;
printing a second image comprising at least two second fiducial marks using a second digital print engine;
selecting matched printer components for a second digital print engine so that a separation of the at least two second fiducial marks on the second print equals the separation of the at least two first fiducial marks on the second print.

10. A method for minimizing the difference in printed image size in a plurality of physically coupled print engines comprising:
grouping two or more matched components in a plurality of coupled print engines such that the matched components have an incremental difference in one or more critical parameters to compensate for target receiver shrinkage;
selecting the matched printer components for the critical parameters for each print engine within a plurality of coupled print engines so that the matched components compensate for target receiver shrinkage.

11. The method according to claim 10 whereby the matched printer components for all of the print engines in the coupled print engines are chosen from a matched set of encoders having a critical parameter.

12. The method according to claim 11 whereby the critical parameter for the encoder is line frequency.

13. The method according to claim 10 whereby the matched printer components for all of the print engines in the coupled print engines are chosen from a matched set of the image writers.

14. The method according to claim 13 wherein the matched set of the image writers are chosen from binned sub-groups based on the measured pitch of the LEDs.

15. The method according to claim 1 whereby the matched printer components comprise critical drive components that affect intrack size.

16. The method according to claim 15 wherein the matched set of are chosen from binned sub-groups of rollers based on a critical parameter.

17. The method according to claim 16 wherein the critical parameter is one or more of roller diameter, roller material, temperature, and thermal conductivity.

18. The method according to claim 1 whereby the matched printer components comprise one or more of a primary imaging member and an intermediate transfer member.

19. The method according to claim 10 whereby the size of a print produced on each print engine is determined by comparing a distance between two or more printed fiducial marks to a distance between two or more fiducial marks on the original file.

20. The method according to claim 10 further comprising:
printing a first image as a first printed image on a first receiver with a first print engine using an original document file comprising at least two first fiducial marks related to an original document file;
measuring a component of a separation of the at least two first fiducial marks on the first print along one side of the receiver along either a length or a width of the receiver;
printing a second image as a second printed image comprising at least two second fiducial marks using a second digital print engine comprising a digital print engine;
selecting match printer components for the second digital print engine so that a separation between the at least two second fiducial marks along either the length or width of the receiver is separately adjusted from the that on the orthogonal axis on each of the prints until the separation of the fiducial marks on the second printed image equals the separation of the at least two first fiducial marks on the first printed image so that the size of the printed images along the length and width of the receiver sheet of separate images formed are adjusted for size.
